(19) United States
(12) Patent Application Publication
(10) Pub. No.: US 2025/0159633 A1
(43) Pub. Date: May 15, 2025

(54) TIME COMPENSATION VIA SIDELINK RELAY IN TELECOMMUNICATION SYSTEMS

(71) Applicant: Nokia Technologies Oy, Espoo (FI)

(72) Inventors: Thomas Haaning JACOBSEN, Nørresundby (DK); Renato Barbosa ABREU, Aalborg (DK); Prajwal KESHAVAMURTHY, Munich (DE)

(21) Appl. No.: 18/837,958

(22) PCT Filed: Feb. 16, 2022
(86) PCT No.: PCT/EP2022/053797

§ 371 Date: Aug. 13, 2024

(51) Int. Cl. H04W 56/00

(52) U.S. Cl. CPC H04W 56/0045; H04W 56/001

(57) ABSTRACT

An apparatus includes a memory and processing circuitry. The processing circuitry is configured to cause the apparatus to request synchronization reference source information from a user equipment, determine whether to conduct an offset compensation based on the synchronization reference source information, and, in response to a determination to conduct the offset compensation, obtain a first propagation delay associated with the apparatus, determine a reference time based on the first propagation delay, and forward the reference time to the user equipment.

### TECHNICAL FIELD

One or more example embodiments relate to wireless communications networks.

### BACKGROUND

Fifth generation (5G) wireless communications networks are the next generation of mobile communications networks. Standards for 5G communications networks are currently being developed by the 3rd Generation Partnership Project (3GPP). These standards are known as 3GPP New Radio (NR) standards.

### SUMMARY

The scope of protection sought for various example embodiments is set out by the independent claims. The example embodiments and/or features, if any, described in this specification that do not fall under the scope of the independent claims are to be interpreted as examples useful for understanding various embodiments.

At least one example embodiment provides an apparatus including a memory and processing circuitry configured to cause the apparatus to request synchronization reference source information from a user equipment, determine whether to conduct an offset compensation based on the synchronization reference source information, and, in response to a determination to conduct the offset compensation, obtain a first propagation delay associated with the apparatus, determine a reference time based on the first propagation delay, and forward the reference time to the user equipment.

According to at least one example embodiment, the processing circuitry is further configured to cause the apparatus to obtain a second propagation delay between the user equipment and the apparatus and obtain a third propagation delay between the user equipment and a synchronization reference source based on the synchronization reference source information.

According to at least one example embodiment, the synchronization reference source information identifies a type of a synchronization source and a priority of the synchronization source.

According to at least one example embodiment, the processing circuitry is further configured to cause the apparatus to determine not to conduct the offset compensation in response to the synchronization source being a global navigation satellite system (GNSS).

According to at least one example embodiment, the processing circuitry is further configured to cause the apparatus to obtain the second propagation delay by transmitting a request to the user equipment to transmit a physical sidelink control channel (PSSCH) transmission with a reference signal including a transmission time and a reception time of a next PSSCH reception from the apparatus, transmitting a first PSSCH transmission to the user equipment, recording a first time of transmitting the first PSSCH transmission to the user equipment, receiving, from the user equipment, a Rx-Tx value corresponding to a difference between the second transmission time of transmitting the second PSSCH transmission to the apparatus and a second reception time of receiving the first PSSCH transmission from the apparatus, and determining the second propagation delay based on the Rx-TX value, the transmission time, and the first reception time.

According to at least one example embodiment, the processing circuitry is further configured to cause the apparatus to set an offset compensation value equal to the first propagation delay, and determine the reference time based on the offset compensation value.

According to at least one example embodiment, the processing circuitry is further configured to cause the apparatus to set an offset compensation value equal to the first propagation delay, and determine the reference time based on the offset compensation value.

According to at least one example embodiment, the processing circuitry is further configured to cause the apparatus to determine whether the second propagation delay is greater than a first threshold and the third propagation delay is greater than a second threshold, and set the offset compensation value equal to the offset compensation value plus the difference between the first propagation delay and the second propagation delay in response to the first propagation delay being greater than the second threshold and the third propagation delay being greater than the second threshold.

According to at least one example embodiment, the processing circuitry is further configured to cause the apparatus to set the offset compensation value equal to the offset compensation value plus the second propagation delay in response to the second propagation delay being greater than the first threshold and the third propagation delay not being greater than the second threshold.

According to at least one example embodiment, the processing circuitry is further configured to cause the apparatus to determine whether the first propagation delay is greater than a third threshold, and set the offset compensation value equal to the offset compensation value minus the first propagation delay in response to the first propagation delay being greater than the third threshold.

At least one example embodiment provides an apparatus including a memory and processing circuitry configured to cause the apparatus to receive, from a first user equipment, a request for time information, obtain a first propagation delay associated with a second user equipment, determine a reference time based on the first propagation delay, and forward the reference time to the first user equipment.

According to at least one example embodiment, the processing circuitry is further configured to cause the apparatus to obtain a second propagation delay between the first user equipment and the second user equipment, and obtain a third propagation delay between the first user equipment and a synchronization reference source.

According to at least one example embodiment, the processing circuitry is further configured to cause the apparatus to set an offset compensation value equal to the first propagation delay, and determine the reference time based on the offset compensation value.

According to at least one example embodiment, the processing circuitry is further configured to cause the apparatus to determine whether a second propagation delay is greater than a first threshold and a third propagation delay is greater than a second threshold, and set the offset compensation value equal to the offset compensation value plus the difference between the first propagation delay and the second propagation delay in response to the first propagation delay being greater than the first threshold and the second propagation delay being greater than the second threshold.

According to at least one example embodiment, the processing circuitry is further configured to cause the apparatus to set the offset compensation value equal to the offset compensation value plus the second propagation delay in response to the second propagation delay being greater than the first threshold and the third propagation delay not being greater than the second threshold.

According to at least one example embodiment, the processing circuitry is further configured to cause the apparatus to determine whether the first propagation delay is greater than a third threshold, and set the offset compensation value equal to the offset compensation value minus the first propagation delay in response to the first propagation delay being greater than the third threshold.

According to at least one example embodiment, the processing circuitry is further configured to cause the apparatus to determine the first threshold based on a variation of a DFN boundary, determine the second threshold based on a roundtrip time of arrival estimation between the first user equipment and the second user equipment, and determine the third threshold based on a variation of a DFN boundary.

At least one example embodiment provides a method for synchronizing a reference time in a sideling relay. The method includes requesting synchronization reference source information from a first user equipment, determining whether to conduct an offset compensation based on the synchronization reference source information, and, in response to a determination to conduct the offset compensation, obtaining a first propagation delay of a second user equipment, determining a reference time based on the first propagation delay, and forwarding the reference time to the first user equipment.

At least one example embodiment provides a method for synchronizing a reference time in a sideling relay. The method includes receiving, from a first user equipment, a request for time information, obtaining a first propagation delay associated with a second user equipment, determining a reference time based on the first propagation delay, and forwarding the reference time to the first user equipment.

At least one example embodiment provides an apparatus including a means for requesting synchronization reference source information from a user equipment, a means for determining whether to conduct an offset compensation based on the synchronization reference source information, and, in response to a determination to conduct the offset compensation, a means for obtaining a first propagation delay associated with the apparatus, a means for determining a reference time based on the first propagation delay, and a means for forwarding the reference time to the user equipment.

At least one example embodiment provides an apparatus including a means for receiving, from a first user equipment, a request for time information, a means for obtaining a first propagation delay associated with a second user equipment, a means for determining a reference time based on the first propagation delay, and a means for forwarding the reference time to the first user equipment.

At least one example embodiment provides a non-transitory computer-readable storage medium storing computer-readable instructions that, when executed, cause one or more processors to cause an apparatus to request synchronization reference source information from a user equipment, determine whether to conduct an offset compensation based on the synchronization reference source information, and, in response to a determination to conduct the offset compensation, obtain a first propagation delay associated with the apparatus, determine a reference time based on the first propagation delay, and forward the reference time to the user equipment.

At least one example embodiment provides a non-transitory computer-readable storage medium storing computer-readable instructions that, when executed, cause one or more processors to cause an apparatus to receive, from a first user equipment, a request for time information, obtain a first propagation delay associated with a second user equipment, determine a reference time based on the first propagation delay, and forward the reference time to the first user equipment.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates a simplified diagram of a portion of a 3rd Generation Partnership Project (3GPP) New Radio (NR) access deployment for explaining example embodiments.

FIG. 2 is a block diagram illustrating an example embodiment of a gNB according to example embodiments.

FIG. 3 is a block diagram illustrating an example embodiment of a UE according to example embodiments.

FIG. 4 in an example timing diagram illustrating a discriminative feature network (DFN) number offset by a Uu interface Propagation Delay.

FIG. 5 is timing diagram according to example embodiments.

FIG. 6 is a flowchart illustrating a method according to example embodiments.

FIG. 7 is a flowchart illustrating an example method for estimating a propagation delay between the remote UE and the relay UE using Rx-Tx based RTT estimation according to example embodiments.

FIG. 8 is a flow chart illustrating an example method for performing offset compensation according to example embodiments.

FIG. 9A is a timing diagram according to example embodiments.

FIG. 9B is a timing diagram according to example embodiments.

FIG. 9C is a timing diagram according to example embodiments.

FIG. 10 shows a signaling flow of the method shown in FIGS. 6-8.

FIG. 11 is a flow chart illustrating an example method for performing offset compensation according to example embodiments.

FIGS. 12A-12B show a signaling flow of a method according to example embodiments.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of radio access network (RAN) or radio network elements (e.g., a gNB), user equipment (UE), or the like, it should be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a radio network element (or user equipment) to perform the operations discussed herein.

As discussed herein the terminology “one or more” and “at least one” may be used interchangeably.

As discussed herein, a gNB may also be referred to as a base station, access point, enhanced NodeB (eNodeB), or more generally, a radio access network element, radio network element, or network node. A UE may also be referred to herein as a mobile station, and may include a mobile phone, a cell phone, a smartphone, a handset, a personal digital assistant (PDA), a tablet, a laptop computer, a phablet, or the like.

It will be appreciated that a number of example embodiments may be used in combination.

Third Generation Partnership Project (3GPP) Release (Rel)-16 introduced accurate time synchronization with support of time sensitive networking (TSN) for industrial communication purposes. 3GPP Rel-17 extended the purpose of accurate time synchronization to cover use cases other than Industrial Internet of Things (IIoT) for use in wide-area deployments suitable for power meters, payment terminals, vehicles, etc. With the help of accurate time synchronization, a UE may acquire an accurate time of day (ToD) relative to a global time domain (e.g., Universal Coordinated Time (UTC)). This may be used directly as a function for how a device behaves (e.g., robots coordinating their actions, or executing at specific time instances), or alternatively, to timestamp events (packets, actions, transactions, etc.) to determine a global order of events, which may be critical for bitcoin generation and financial transactions.

Accurate 5G System (5GS) time synchronization may be enabled with a framework having two aspects: first, specific events may be identified at the air interface, timestamping these events at the gNB, and then the UE may identify these events and receive the timestamp relative to these events from the gNB to acquire a ToD; second, accurate 5GS time synchronization may further include mechanisms for the propagation delay compensation (PDC).

With respect to mechanisms for PDC, the air interface events timestamped by the gNB is the ending boundary of a reference system frame number (SFN). The timestamp is carried in a ReferenceTimeInfo-r16 information element (IE) (RTI) that can be transmitted in a SIB9 (e.g., for broadcasting), or the RTI can be delivered via dedicated radio resource control (RRC) signaling as a part of DLInformationTransfer. In the case of the RRC carried RTI, the reference SFN that the timestamp refers to is explicitly given (can be back or forth in time), but in the case of the system information block (SIB)9 carried RTI, the reference SFN is implicitly given by the SFN in which the ongoing system information window (SI-window) ends.

Sidelink (SL) communications may extend coverage by allowing UEs that are out of gNB coverage to be serviced. For example, with 3GPP Rel-16, a first version of NR SL supports vehicle-to-everything (V2X) related services, while Rel-17 provides further coverage extensions for sidelink-based communication, such as UE-to-network (U2N) coverage extension and UE-to-UE coverage extension in 3GPP Rel-18. In order to support UE-to-network relays, SIB forwarding may be enabled in order to allow a remote UE to obtain system information from the network.

A challenge in using the underlying 5G radio frame timing at the gNB and the UE as a common reference for delivery of Time of Day (ToD) is that radio frame boundaries (hence SFN boundaries) at the gNB and the UE are not perfectly aligned in time with respect to one another. A downlink frame boundary at the UE is shifted by a propagation delay (PD), i.e., by the time it takes for the radio frame to propagate from the gNB to the UE over the air, with respect to the corresponding frame boundary at gNB. When a UE synchronizes its clock timing by associating time information carried by a SIB9/RRC message with its own refSFN boundary, the UEs understanding of ToD will be delayed by the PD compared to the gNB's ToD. This may not be an issue if the PD is relatively small compared to the maximum allowed timing error (e.g., every 10 m of distance may add 33.3 ns of time error between UE and gNB clocks due to PD). However, considering that the maximum synchronization error over 5G RAN may be less than 275 ns for each Uu interface in a control-to-control scenario in Release-17, and possibly even smaller in future releases, and that the UE's distance from the gNB may be such that the PD alone would introduce a much larger error, the inventors have discovered a need to compensate for this offset. Therefore, the UE according to example embodiments may compensate for the PD on the time information received in a SIB9 or unicast RRC message, e.g., by adding its current PD estimate to the time information.

Acquisition of a PD estimation uses a measurement of the link delay, typically estimated from a Rx-Tx round trip time (RTT) measurement assuming symmetric delays in UL/DL. This can be obtained through a positioning framework (multi-RTT measurements) or through a UE timing advance (TA) which is a metric of how much the UE's UL transmission should be advanced relative to the DL reception time. Once achieved, an approximation of the DL PD is RTT/2.

In TA procedures the UE may receive a TA command from a gNB during random access procedure or after any UL transmission via a medium access control (MAC) message. In multi-RTT the UE may be configured to measure DL reference signals (RS) while the gNB measures UE UL RS transmissions timing of arrival. The RTT procedure of positioning can be simplified for applying to time sync PD estimation as only single cell Rx-Tx measurements are needed.

The transmission time at the PC5 interface depends on whether or not the UE is a synchronization reference (SyncRef) UE (e.g., a PC5 synchronization master which will then be broadcasting S-SSB) and on the time synchronization source which can be within the categories gNB/eNB, GNSS, and/or other.

Depending on the synchronization source detected the UE will initiate transmission time on the PC5 timing slightly different. 3GPP TS38.331, 6.3.4 specifies the UE performance requirements and includes Uu and PC5 transmission timing requirements. For PC5 transmission, timing requirements depend on the synchronization source type. The entire contents of 3GPP TS38.331, 6.3.4 are incorporated herein by reference.

In Release-16, a UE selects its SyncRef based on the different priorities of the sources as summarized in Table 1 (where P0 to P6 correspond to highest to lowest priorities, respectively) depending on whether it is a GNSS-based synchronization (GNSS as the highest priority) or gNB/eNB-based synchronization (gNB/eNB has the highest priority).

TABLE 1

| GNSS-based synchronization | gNB/eNB-based synchronization |
|---|---|
| P0: GNSS | P0′: gNB/eNB |
| P1: UE directly synchronized to | P1′: UE directly synchronized to |
| GNSS | gNB/eNB |
| P2: UE indirectly synchronized | P2′: UE indirectly synchronized |
| to GNSS | to gNB/eNB |
| P3: gNB/eNB | P3′: GNSS |
| P4: UE directly synchronized to | P4′: UE directly synchronized to |
| gNB/eNB | GNSS |
| P5: UE indirectly synchronized | P5′: UE indirectly synchronized |
| to gNB/eNB | to GNSS |
| P6: the remaining UEs have the | P6′: the remaining UEs have the |
| lowest priority. | lowest priority. |

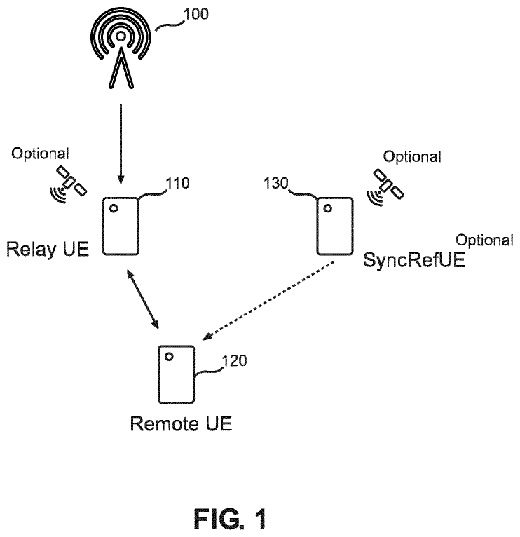

FIG. 1 illustrates a simplified diagram of a portion of a 3rd Generation Partnership Project (3GPP) New Radio (NR) access deployment for explaining example embodiments.

The portion of the 3GPP NR access deployment shown in FIG. 1 illustrates an example of a sidelink connection, according to example embodiments. The sidelink connection shown in FIG. 1 includes a UE-to-network relay UE (relay UE) 110, a remote UE 120, a SyncRef UE 130, and a gNB 100. The relay UE 110 may be configured to relay ReferenceTimeInfo (RTI) to the remote UE 120. The relay UE 110 and the remote UE 120 might not have selected the same SyncRef UE 130. In some example embodiments, the relay UE 110 may also act as the SyncRef UE 130.

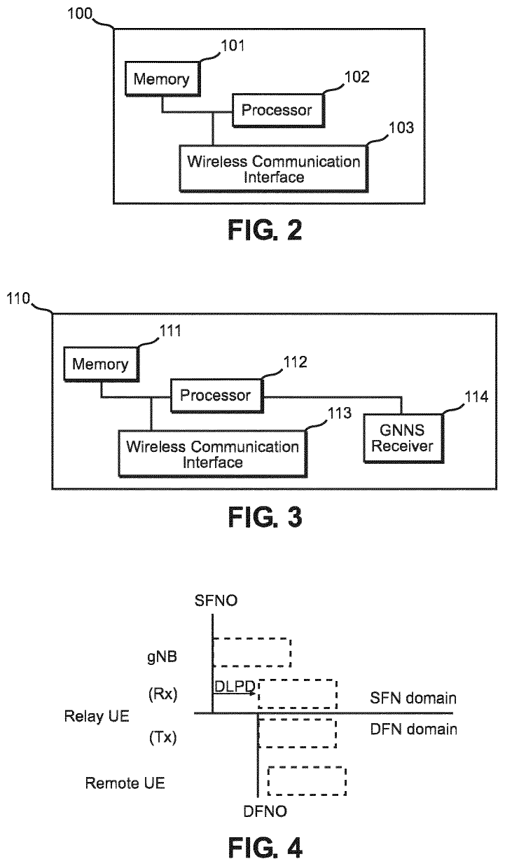

FIG. 2 is a block diagram illustrating an example embodiment of a gNB according to example embodiments.

Referring to FIG. 2, the gNB 100 may also be referred to as a base station, access point, enhanced NodeB (eNodeB), or more generally, a radio access network element, radio network element, or network node. The gNB 100 may include a memory 101, processing circuitry (such as at least one processor 102), and/or a wireless communication interface 103. The memory 101 may include various special purpose program code including computer executable instructions which may cause the gNB 100 to perform the one or more of the methods of the example embodiments. The wireless communication interface may include a PC5 air interface.

In at least one example embodiment, the processing circuitry may include at least one processor (and/or processor cores, distributed processors, networked processors, etc.), such as the at least one processor 102, which may be configured to control one or more elements of the gNB 100, and thereby cause the gNB 100 to perform various operations. The processing circuitry (e.g., the at least one processor 102, etc.) is configured to execute processes by retrieving program code (e.g., computer readable instructions) and data from the memory 101 to process them, thereby executing special purpose control and functions of the entire gNB 100. Once the special purpose program instructions are loaded into, (e.g., the at least one processor 102, etc.), the at least one processor 102 executes the special purpose program instructions, thereby transforming the at least one processor 102 into a special purpose processor.

In at least one example embodiment, the memory 101 may be a non-transitory computer-readable storage medium and may include a random access memory (RAM), a read only memory (ROM), and/or a permanent mass storage device such as a disk drive, or a solid state drive. Stored in the memory 101 is program code (i.e., computer readable instructions) related to operating the gNB 100.

FIG. 3 is a block diagram illustrating an example embodiment of a UE according to example embodiments.

Referring to FIG. 3, the relay UE may include a memory 111, processing circuitry (such as at least one processor 112), a wireless communication interface 113, and/or a global navigation satellite system (GNNS) receiver 114. The relay UE 110 may be any one of, but not limited to, a mobile device, a smartphone, a tablet, a laptop computer, a desktop computer and/or the like.

Descriptions of the memory 111, the processor 112, and the wireless communication interface 113 may be substantially similar to the memory 101, the processor 102, and the communication interface 103, respectively, and are therefore omitted. The GNNS receiver may be an interface for communicating with and/or receiving a signal from a GNNS.

Descriptions of the configurations of the remote UE 120 and the SyncRef UE 130 may be substantially similar to the relay UE 110, and are therefore omitted.

Referring back to FIG. 1, when the remote UE 120 uses a SyncRef source that is either direct or indirect gNB/eNB, its PC5 reception time may be offset relative to the SFN boundary time transmitted at the gNB 100 by a Uu interface propagation delay (experienced at the remote UE 120 in a case of a direct synchronization to a gNB/eNB, or the SyncRef UE 130 in case direct or indirect gNB/eNB synchronization). This offset reflects as an additional ToD error when the remote UE 120 reads the timestamp carried in RTI. The Uu propagation delay can be several hundreds of ns and the resulting ToD error might not be acceptable for some time synchronization use cases using accuracies of less than 1 μs.

FIG. 4 is an example timing diagram illustrating a problem where a DFN number is offset by a Uu interface Propagation Delay.

Referring to FIG. 4, an offset between the perceived DFN boundary at the remote UE 120 and the timestamped SFN boundary indicated in RTI occurs when the SyncRef UE 130 (to which the remote UE 120 PC5 air interface is synchronized) or the remote UE 120 itself is using an eNB/gNB as SyncRef source for its PC5 air interface. In this case, the PC5 transmission time offsets by at least the propagation delay from the eNB/gNB to the SyncRef UE 130 (indirectly sync case) or the remote UE 120 (direct sync case).

Additionally, the relay UE 110 (relaying RTI) might not be the same device as the SyncRef UE 130 (and the SyncRef UE 130 used by the remote UE 120 might not be the same as used by the relay UE 110). In this case, the relay UE 110 might not know the timing source of the SyncRef UE 130 used by the remote UE 120. Consequently, the RTI forwarded by the relay UE 110 to the remote UE 120 may provide inaccurate ToD at the remote UE 120 due to SFN and DFN misalignment. This may affect IIoT-like use cases which can use high timing accuracy.

Some example embodiments relate to a method and an apparatus for improving accuracy of relayed RTI information via sidelink at the remote UE 120. The RTI information may be requested by the remote UE.

For example, the remote UE 120 may move out of range of coverage by a gNB. In this case, the remote UE 120 may request time synchronization services for at least one of the following reasons: Supporting TSN, TSC and/or PTP clock synchronization and/or native sync of 5G clock for the purpose of having a global time domain understanding. The remote UE 120 may request the time service as described in U.S. Provisional Application No. 63/270,528, the entire contents of which are incorporated herein by reference.

As another non-limiting example, the remote UE 120 connected by sidelink to the gNB 100 via the relay UE 110 may request time synchronization services in response to a request from an application running on the remote UE 120.

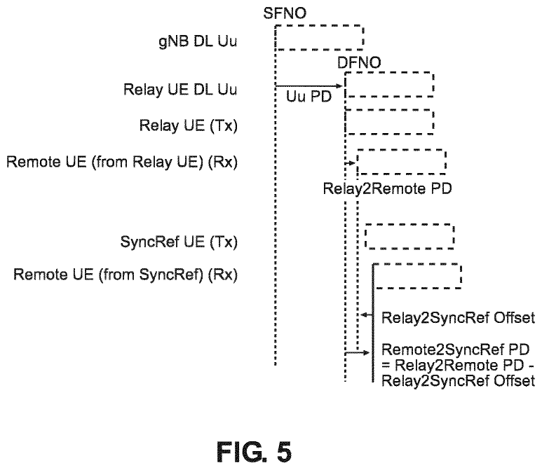

FIG. 5 is timing diagram showing offsets that may be compensated for according to example embodiments.

As shown in FIG. 5, there may be a first propagation delay Uu PD between the relay UE 110 and the gNB 100. A second offset between the perceived DFN boundary at the remote UE 120 and the timestamped SFN boundary indicated in RTI may be caused by a propagation delay Relay2Remote PD between the remote UE and the relay UE. A third offset Relay2SyncRef may be caused by a propagation delay between the remote UE and a SyncRef source of the remote UE. Example embodiments may compensate for these offsets by calculating a Remote2SyncRef PD offset, described later.

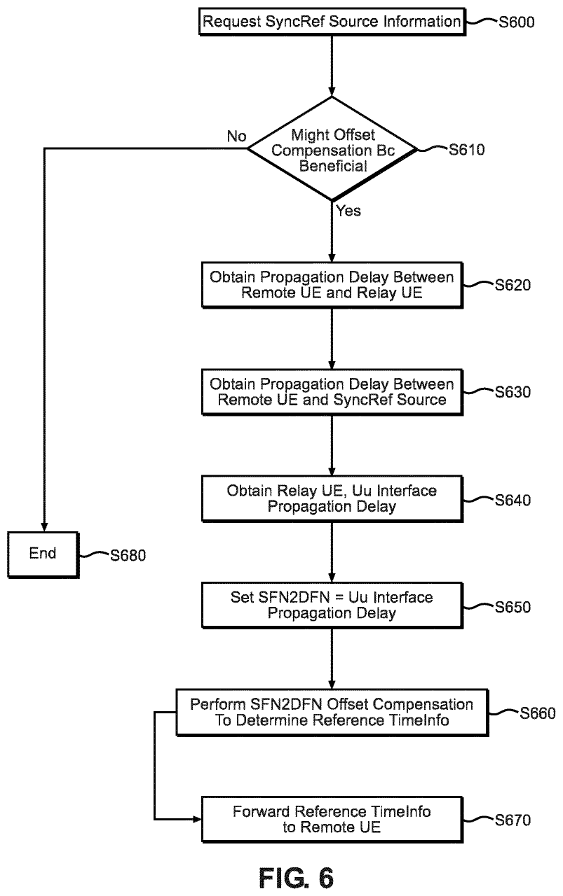

FIG. 6 is a flowchart illustrating a method according to example embodiments.

Referring to FIG. 6, at S600 in response to a request from the remote UE 120, the relay UE 110 may request sync ref source information from the remote UE 120. The remote UE 120 may respond by transmitting, to the relay UE 110, its SyncRef source type. For example, the remote UE 120 may transmit SyncRef source information including 4 bits. A first bit of the SyncRef source information may indicate GNSS or gNB/eNB based synchronization. 3 bits of the SyncRef source information may indicate a priority of the SyncRef source, as shown in Table 1.

At S610, the relay UE 110 determines, based on the SyncRef source information provided by the remote UE 120, whether offset compensation might be beneficial (or necessary) to perform. For example, the relay UE 110 may determine whether the SyncRef UE 130 is performing synchronization based on a GNSS source, or a gNB/eNB source based on the first bit of the SyncRef source information.

If the SyncRef UE 130 is performing synchronization based on a GNSS source, the relay UE 110 determines that offset compensation would not be beneficial (or necessary) (NO at S610), and proceeds to S680.

At S680, the method ends.

Returning to S610, if the SyncRef UE 130 is not performing synchronization based on a GNSS source, then the relay UE 110 determines that offset compensation might be beneficial (YES at S610) and proceeds to S620.

At S620, the relay UE 110 obtains a propagation delay Relay2Remote PD between the remote UE 120 and the relay UE 110. The Relay2Remote PD may be estimated according to any known method for estimating propagation delay. For example, by using Rx-Tx based RTT estimation, using zones, signal levels, and/or Mode 1 physical sidelink control channel (PSSCH).

Zones may be used for estimating the Relay2Remote PD by the remote UE 120 and the relay UE 110 calculating and exchanging their respective Zone IDs based on their respective geographic coordinates and a configured zone length. The relay UE 110 may then estimate a distance, based on the difference between the zones and the zone length. The estimated difference can then be translated to the Relay2Remote PD. For example, the Relay2Remote PD may be estimated based on the time a signal takes to propagate at the speed of light c between the relay UE 110 in one zone to the remote UE 120 in another zone. For example, if zone length is z and the relay UE 110 is found to be in zone n, while the remote UE 120 is in zone m, the Relay2Remote PD can be estimated by Equation 1.

$$\frac{\vert m - n \vert * z}{c} \qquad Equation l$$

In another example embodiment, signal levels may be used for estimating the Relay2Remote PD by the relay UE 110 estimating the Relay2Remote PD based on a signal level received from other UE transmissions. For example, the relay UE 110 may measure a sidelink resource occupancy level (SL RSRP) and map the SL RSRP to a corresponding Relay2Remote PD value.

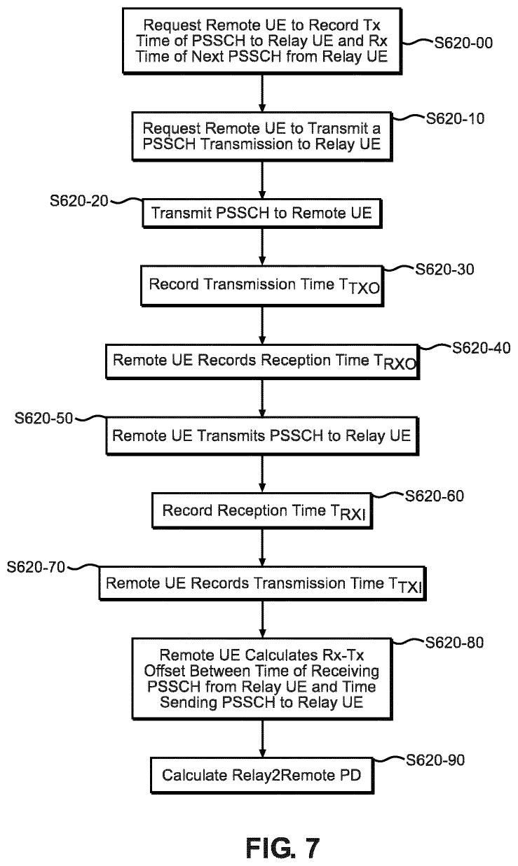

FIG. 7 is a flowchart illustrating an example method for estimating a propagation delay between the remote UE 120 and the relay UE 110 using Rx-Tx based RTT estimation according to example embodiments.

Referring to FIG. 7, at S620-00 the relay UE 110 transmits a request to the remote UE 120 to record a reception time T_{Rx1} of a first PSSCH transmission received from the relay UE 110, and to record a transmission time T_{Tx1} of a second PSSCH transmission transmitted to the relay UE 110.

At S620-10, the relay UE 110 transmits a request to the remote UE 120 to transmit the second PSSCH transmission with a reference signal (RS) (e.g., demodulation reference signal (DMRS)) to the relay UE 110.

At S620-20, the relay UE 110 transmits the first PSSCH transmission with a RS (e.g., DMRS) to the remote UE 120.

At S620-30, the relay UE 110 records a transmission time T_{Tx0} of the first PSSCH transmission to the remote UE 120.

At S620-40, the remote UE 120 records the reception time T_{Rx1} of the first PSSCH transmission received from the relay UE 110.

At S620-50, the remote UE 120 transmits the second PSSCH to the relay UE 110.

At S620-60, the relay UE 110 records a reception time (T_{Rx0}) of the second PSSCH received from the remote UE 120.

At S620-70, the remote UE 120 records a transmission time (T_{Tx1}) of the second PSSCH.

At S620-80 the remote UE 120 calculates an Rx-Tx offset between the reception time of the first PSSCH from the relay UE 110 T_{Rx1} and the transmission time of the second PSSCH transmission T_{Tx1} to the relay UE 110, and transmits the calculated T_{Rx1}−T_{Tx1} offset value to the relay UE 110.

At S620-90, the relay UE 110 calculates the Relay2Remote PD based on the calculated T_{Rx1}−T_{Tx1} value received from the remote UE 120, and the transmission time T_{Tx0} and reception time T_{Rx0} recorded at the relay UE 110. For example, the relay UE 110 may calculate the Relay2Remote PD according to Equation 2.

$$( ( {T}_{Rx 0} - {T}_{Tx 0} ) + ( {T}_{Rx 1} - {T}_{Tx 1} ) ) / 2. \qquad Equation 2$$

Returning to FIG. 6, at S630 the relay UE 110 obtains a propagation delay between the remote UE 120 and a SyncRef source of the remote UE 120. For example, the relay UE 110 may request the remote UE 120 to measure an offset between the remote UE 120 and its associated SyncRef source. According to some example embodiments, the SyncRef source may be the SyncRef UE 130.

The remote UE 120 may measure the offset between the remote UE 120 and its associated SyncRef source at the next DFN boundary. The remote UE 120 may measure the offset extrapolated from symbol timing. For example, remote UE 120 may measure the offset using a Relative Time of Arrival (RToA) method.

The remote UE 120 may perform the RToA by measuring time of arrival from a first reference signal (e.g., DMRS, CSI-RS, etc.) from a first source and a time of arrival of a second reference signal from a second source. For example, the remote UE 120 may request the SyncRef UE 130 to send the first reference signal and the remote UE 120 may request the relay UE 110 to send the second reference signal. If the time of arrival of the first reference signal and the time of arrival of the second reference signal occur at different DFNs (e.g., the times of arrival are so far apart that they would refer to two different DFNs), the remote UE 120 translates the ToA to the nearest DFN frame boundary for each of them. Then the remote UE 120 reads the DFN number of the frame boundaries from the sidelink control information. If the DFN numbers refer to different DFNs, the remote UE 120 adds the known DFN length (e.g., 1 ms) such that the time stamps both refer to the same SFN. Then the remote UE 120 calculates the offset of the two times of arrivals based on the time stamps as a Relay2SyncRef offset. Then, the remote UE 120 reports the Relay2SyncRef offset to the relay UE 110.

Returning to FIG. 6, at S640 the relay UE 110 obtains its Uu interface propagation delay (Uu PD). The relay UE 110 may obtain the Uu PD by any known method. For example, the relay UE 110 may obtain the Uu PD via legacy timing advance (TA), enhanced TA, and/or Round-Trip-Time (RTT). The relay UE 110 may determine a PD compensated SFN boundary based on the Uu PD.

At S650, the relay UE 110 sets a local variable equal to the Uu PD. For example, the relay UE may set a local variable SFN2DFN equal to the Uu PD.

At S660 the relay UE 110 performs offset compensation to determine a compensated ReferenceTime Info.

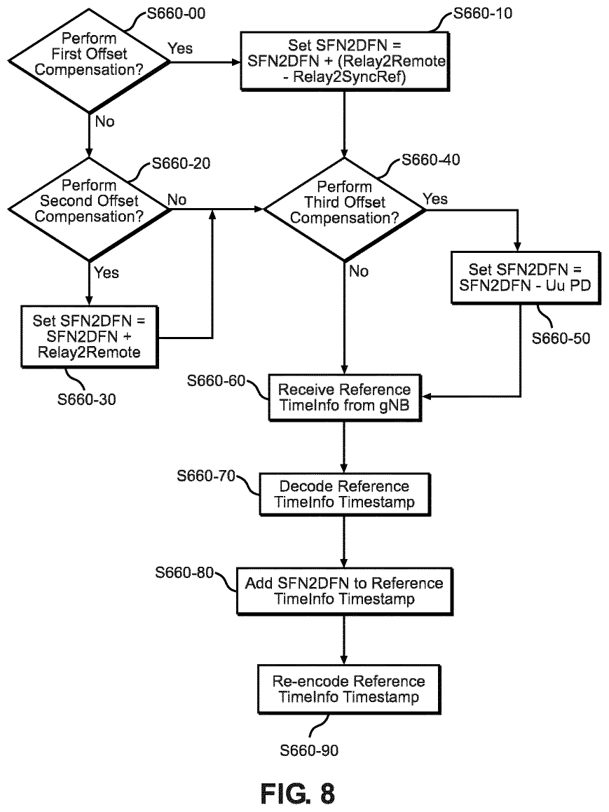

FIG. 8 is a flow chart illustrating an example method for performing offset compensation according to example embodiments.

If offset components (e.g., Relay2Remote PD, Relay2SyncRef PD, and/or Uu PD) are too small compared to an estimation/measurement accuracy employed in acquiring the offset components, then using the acquired offset components to determine a compensated offset may risk introducing a larger error than using the uncompensated time information. The relay UE 110 may therefore determine whether to perform a first offset compensation, a second offset compensation, and/or a third offset compensation by comparing the Uu PD, the Relay2Remote PD, and/or the Relay2SyncRef PD, with a first threshold T1, a second threshold T2, and/or a third threshold T3, respectively. The first through third thresholds T1-T3 may be determined by the gNB 100. Determination of the first through third thresholds T1-T3 will be discussed in more detail later.

Referring to FIG. 8, at S660-00 the relay UE 110 determines whether to perform a first offset compensation by comparing the Relay2Remote PD and the Relay2SyncRef PD with the second threshold T2 and the third threshold T3, respectively. Specifically, the relay UE 110 determines whether the Relay2Remote PD is greater than the second threshold T2 and the relay UE 110 determines whether the Relay2SyncRef PD is greater than the third threshold T3. If the Relay2Remote PD is greater than the second threshold T2, and the Relay2SyncRef PD is greater than the third threshold T3 (YES at S660-00) the relay UE 110 performs the first offset compensation at S660-10. The first offset compensation will be described in more detail later.

If the Relay2Remote PD is not greater than then second threshold T2, or the Relay2SyncRef PD is not greater than the third threshold T3 (NO at S660-00), then the relay UE 110 determines whether to perform a second offset compensation at S660-20.

At S660-20, the relay UE 110 determines whether to perform the second offset compensation by comparing the Relay2Remote PD with the second threshold T2. If the Relay2Remote PD is not greater than the second threshold T2 (NO at S660-20), then the relay UE 110 determines whether to perform a third offset compensation at S660-40. S660-40 will be described in more detail later.

If the Relay2Remote PD is greater than the second threshold T2 (YES at S660-20), then the relay UE 110 performs the second offset compensation at S660-30. Restated, if the Relay2Remote PD is greater than the second threshold T2, and the Relay2SyncRef PD is not greater than the third threshold T3, then the relay UE 110 may perform the second offset compensation.

At S660-30, the relay UE 110 performs the second offset compensation by updating SFN2DFN to be SFN2DFN plus the Relay2Remote PD. The process then proceeds to S660-40.

Returning to S660-10, if the Relay2Remote PD is greater than the second threshold T2, and the Relay2SyncRef PD is greater than the third threshold T3 (YES at S660-00), then the relay UE 110 performs the first offset compensation by updating SFN2DFN to be equal to a difference between the Relay2Remote PD and the Relay2SyncRef PD added to the SFN2DFN. The process then proceeds to S660-40.

At S660-40, the relay UE 110 determines whether to perform the third offset compensation based on the Uu PD and the first threshold. The relay UE 110 may determine whether the Uu PD is greater than the first threshold.

If the Uu PD of the relay UE 110 is not greater than the first threshold T1 (NO at S660-40), then the relay UE 110 receives a ReferenceTimeInfo timestamp from the gNB 100 at S660-60, described in more detail later.

If the Uu propagation delay of the relay UE 110 is greater than the first threshold T1 (YES at S660-40), then the relay UE 110 performs the third compensation offset at S660-50 by updating SFN2DFN to be equal to the difference between SFN2DFN and the Uu PD according. The process then proceeds to S660-60.

At S660-60 the relay UE 110 receives, from the gNB 100, a first ReferenceTimeInfo timestamp. The first ReferenceTimeInfo timestamp may be received from the gNB 100 via, for example, SIB9 and/or RRC. For example, the gNB 100 may provide the ReferenceTimeInfo timestamp in a broadcast signal in a case where the first ReferenceTimeInfo timestamp is received via SIB9. In a case where the first ReferenceTimeInfo timestamp is received via RRC, the gNB 100 may provide the first ReferenceTimeInfo timestamp in response to a request from the relay UE 110 via a ReferenceTimeInfoPreference field in UEAssistanceInformation IE, as described in 3GPP TS 38.331. Alternatively, the relay UE 110 may forward a request from the remote UE 120 to receive the ReferenceTimeInfo as described in U.S. Provisional Application 63/270,528.

At S660-70 the relay UE 110 decodes the ReferenceTimeInfo timestamp. The ReferenceTimeInfo timestamp may be decoded using any known method to a ReferenceTimeInfo value. For example, the ReferenceTimeInfo may include ReferenceTime-r16 information (e.g., UTC time information) where the days, seconds, milliseconds, and nanoseconds are encoded as integers and delivered via SIB9 or RRC, as described above.

At S660-80 the relay UE 110 updates the ReferenceTimeInfo value by adding the offset compensation value SFN2DFN to the ReferenceTimeInfo value.

At S660-90 the ReferenceTimeInfo value is encoded to a second ReferenceTimeInfo timestamp using any known method. For example, the relay UE 110 may encode the ReferenceTimeInfo value to ReferenceTimeInfo-r16 information.

Returning to FIG. 6, at S670 the relay UE 110 forwards the second ReferenceTimeInfo timestamp to the Remote UE 120.

In some example embodiments, as an alternative to the method shown in FIGS. 6-8, S660-60 to S660-90 may be omitted, and the relay UE 110 may not incorporate the SFN2DFN offset into the RefenceTimeInfo timestamp. In this case, at S670 the relay UE 110 forwards the SFN2DFN offset to the remote UE 120. This has the benefit that no decoding and encoding of the ReferenceTimeInfo timestamps is performed at the relay UE 110, and the SFN2DFN offset may be forwarded “as is.”

In some example embodiments, the relay UE 110 may transmit the SFN2DFN offset to the gNB 100, instead of transmitting the SFN2DFN offset or the ReferenceTimeInfo timestamp to the remote UE 120. In this case the gNB 100 may perform PD pre-compensation on the ReferenceTimeInfo timestamp, using the SFN2DFN offset, before transmitting the ReferenceTimeInfo timestamp to the remote UE 120.

In some example embodiments, at S600, the relay UE 110 may request and obtain Sidelink Synchronization Signals Identifier (SLSS ID) and in-coverage status of the SyncRef UE 130 if the SyncRef source of the remote UE 120 is a SyncRef UE. Here, SLSS ID provides the identifier of the SyncRef UE 130 and together with an in-coverage indicator, the relay UE 110 can identify the SyncRef UE 130 uniquely in its vicinity. In this case, at S630 the Relay UE may obtain the propagation delay between the remote UE 120 and the SyncRef UE 130 by monitoring the SL-SSB transmitted by the SyncRef UE 130. If the relay UE 110 can also listen to this SyncRef UE 130, the relay UE 110 may determine the Relay2SyncRef offset without requesting further information or processing from the remote UE 120.

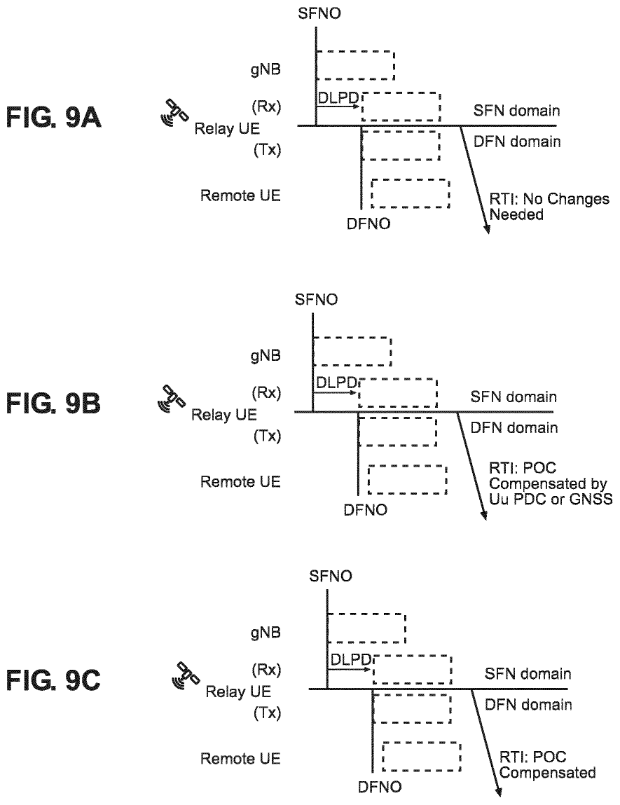

FIGS. 9A-9C are example timing diagrams according to example embodiments.

Referring to FIGS. 9A-9C, the timing diagrams shown in FIGS. 9A-9C represent a case where the relay UE 110 is also acting as a SyncRef UE 130 for the remote UE 120.

Referring to FIG. 9A, the timing diagram shown in FIG. 9A shows a timing resulting from a case where the relay UE 110 includes a GNSS receiver and is configured to use the GNSS as its synchronization source. In this case, as shown in the timing diagram of FIG. 9A, the relay UE 110 will most likely not perform the offset compensation.

Referring to FIG. 9B, the timing diagram shown in FIG. 9B shows a timing resulting from a case where the relay UE 110 includes a GNSS receiver, but is configured to use the gNB 100 as its synchronization source. In this case, as shown in the timing diagram of FIG. 9B, the relay UE 110 will most likely perform the offset compensation.

Referring to FIG. 9C, the timing diagram shown in FIG. 9C shows a timing resulting from a case where the relay UE 110 does not include a GNSS receiver. In this case, as shown in the timing diagram of FIG. 9C, the relay UE 110 will most likely perform the offset compensation.

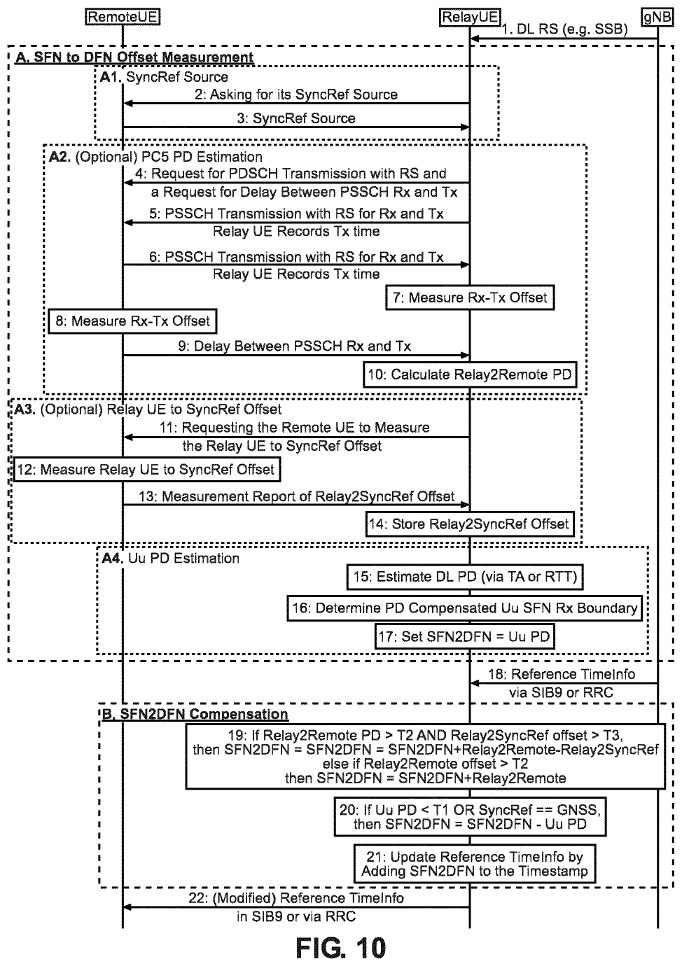

FIG. 10 shows a signaling flow of the method shown in FIGS. 6-8.

Descriptions of the steps shown in FIG. 10 may be substantially similar to those described with reference to FIGS. 6-8. Repeated descriptions are therefore omitted.

As discussed above, first through third thresholds T1-T3 may be determined by the gNB 100. The first threshold T1 may correspond with an estimate for how large a smallest size of the Uu PD is with which it makes sense to offset the PD. The second threshold T2 may correspond with an estimation of a PD between the relay UE 110 and the remote UE 120. The third threshold T3 may correspond with timing difference between the relay UE 110 and the SyncRef UE 130 experienced by the remote UE 120.

In some example embodiments, the gNB 100 may determine at least one of the first through third thresholds T1-T3 by monitoring the variation of the DFN boundary, e.g., by collecting statistics. If the variation is large compared to the PD value of the Uu interface (e.g., the PD between the gNB 100 and the relay UE 110) it may not be beneficial to offset the PD, and the gNB 100 sets first threshold T1 similar to or the same as (e.g., at least in the order of) the Uu PD value. If not, the gNB 100 may set the first threshold T1 lower. This will be subject for empirical adjustments.

The gNB 100 may determine the second and/or third thresholds T2 and T3 in a similar manner as the first threshold, for the respective associated PDs. For example, the gNB 100 may determine if the variation of the DFN boundary is large compared to a PD between the relay UE 110 and the remote UE 120 (e.g., the Relay2Remote PD) the gNB 100 may set the second threshold T2 similar to or the same as (e.g., at least in the order of) the Relay2Remote PD value. If not, the gNB 100 may set the second threshold T2 lower. Similarly, the gNB 100 may determine if the variation of the DFN boundary is large compared to a PD between the SyncRef UE 130 and the relay UE 110 (e.g., the Relay2Sync PD).

In some example embodiments, the gNB 100 may determine at least one of the first through third thresholds T1-T3 by configuration. By assuming some performance on each PC5 hop (e.g., from the SyncRef UE 130 to the remote UE 120) each would introduce an error. In the worst case, this error is given by the transmission error (Te) for a UE to apply Tx time to PC5. For example, the gNB 100 may configure the first through third thresholds T1-T3 taking into account a maximum allowed transmit timing error of the remote UE 120. For example, the threshold may be higher than the transmission error Te specified in section 7 of 3GPP TS 38.133 for the Uu interface, and section 12.2 of 3GPP TS 38.133 for the sidelink interface.

In some example embodiments, instead of the relay UE 110 performing the PD offset compensation, the gNB 100 may perform the PD offset compensation.

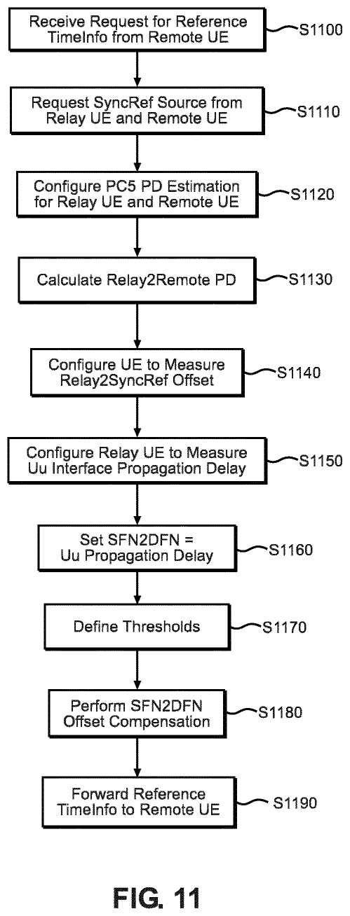

FIG. 11 is a flow chart illustrating an example method for performing offset compensation according to example embodiments.

Some operations shown in FIG. 11 may be substantially similar to operations described with regard to FIG. 6. Descriptions of such operations are therefore omitted.

Referring to FIG. 11, at S1100 the gNB 100 receives a request for RTI information (e.g., ReferenceTimeInfo) from the remote UE 120.

At S1110, the gNB requests and receives synchronization reference source information from the remote UE 120 and the relay UE 110. The synchronization reference source information is described above with regard to S600. A repeat description will therefore be omitted.

At S1120, the gNB configures PC5 PD estimation for the relay UE 110 and the remote UE. The gNB 100 configures an Rx-Tx procedure on the relay UE 110 and the remote UE 120, and receives an RxTx₁ value from the relay UE 110 and an RxTx₂ value from the remote UE 120. The Rx-TX procedure may be known method. For example, in some example embodiments the gNB 100 may configure the relay UE 110 and the remote UE 120 to conduct an Rx-Tx measurement between the next (in time) PC5 transmissions starting from a specified DFN boundary, that includes a reference signal (e.g., DM-RS). The gNB 100 may then configure a PC5 allocation on each of the relay UE 110 and the remote UE 120 as close as possible to this DFN boundary.

In some example embodiments, channel state information reference signal (CSI-RS) can be used which all have a unique ID. The transmissions over PC5 is all over the physical sidelink shared channel (PSSCH) and are not to the gNB 100. The gNB 100 may configure the CSI-RS via RRC signaling as specified in 3GPP TS 38.331.

At S1130, the gNB 100 calculates the Relay2Remote PD based on the RxTx₁ and RxTx₂. For example, the gNB 100 cay calculate the Relay2Remote PD according to Equation 3.

$$Relay 2 Remote = ( R x T {x}_{1} + R x T {x}_{2} ) / 2 \qquad Equation 3$$

At S1140, the gNB 100 configures the remote UE 120 to measure a propagation delay Relay2SyncRef offset between the remote UE 120 and the SyncRef UE 130. The remote UE 120 may obtain this propagation delay as described with reference to S630. Thus, a repeated description is omitted. The gNB 100 receives the calculated Relay2SyncRef offset from the remote UE 120.

At S1150, the gNB 100 obtains a Uu propagation delay of the relay UE 110. The gNB 100 may request the relay UE 110 to obtain and provide the Uu propagation delay of the relay UE 110. In this case, the relay UE obtains its Uu propagation delay, as described with reference to S640.

In some example embodiments, the gNB 100 may determine the Uu PD of the relay UE 110. For example, the gNB 100 may determine the Uu PD of the relay UE 110 by TA. The TA value may be configured for offsetting the UL transmission. The gNB 100 may determine the Uu PD to be equal to TA/2. For another example, the gNB 100 may determine the Uu PD of the relay UE 110 from a Rx-Tx round trip time (RTT) measurement assuming symmetric delays in UL/DL. This can be obtained through a positioning framework (multi-RTT measurements). The gNB 100 may then determine the Uu PD to be equal to RTT/2.

At S1160, the gNB 100 sets a local variable equal to the Uu propagation delay of the relay UE 110. For example, the relay UE may set a local variable SFN2DFN equal to the Uu PD.

At S1170, the gNB 100 may define first through third thresholds T1-T3. A description is provided above for the gNB 100 defining first through third thresholds T1-T3. Therefore, a repeated description is omitted.

At S1180, the gNB 100 may perform offset compensation. Performance of offset compensation by the gNB 100 may be substantially the same as the performance of the offset compensation performed by the relay UE 110, described with reference to S660 and FIG. 8. A repeated description is therefore omitted.

At S1190, the gNB 100 may forward the ReferenceTimeInfo to the remote UE 120.

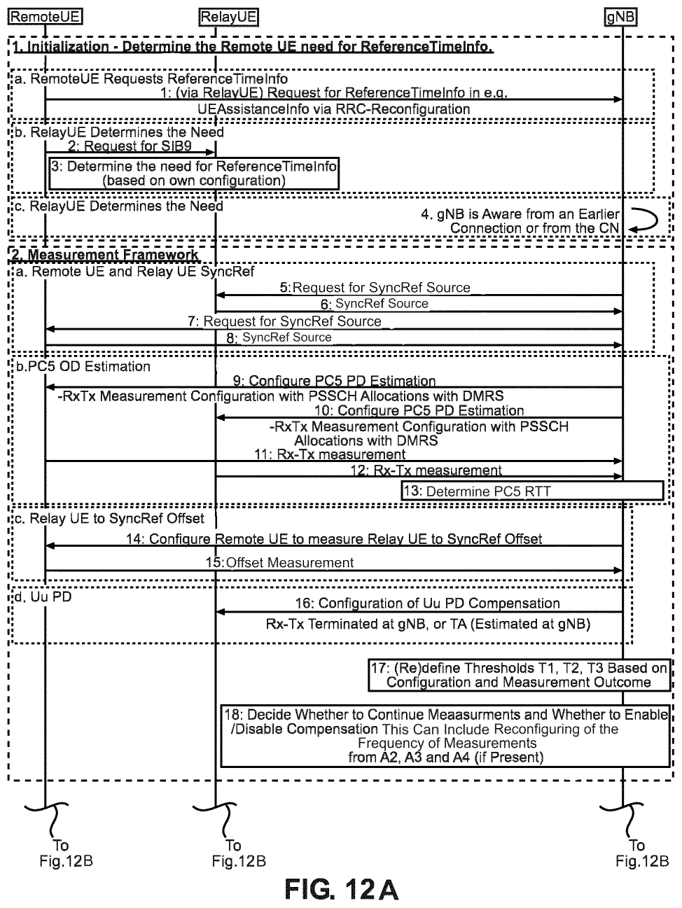

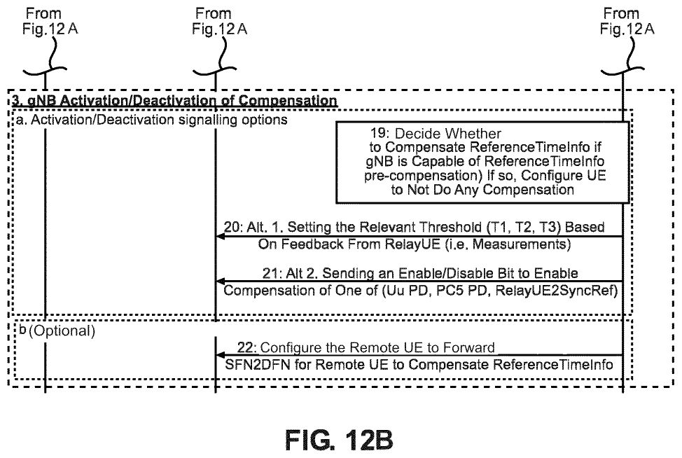

FIGS. 12A-12B show a signaling flow of the method shown in FIG. 11.

The operations shown in FIGS. 12A-12B may be substantially similar to operations described with regard to FIG. 11. Descriptions of such operations are therefore omitted.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing user equipment, base stations, eNBs, RRHs, gNBs, femto base stations, network controllers, computers, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although directly, and not necessarily not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, base stations, eNBs, RRHs, gNBs, femto base stations, network controllers, computers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUS, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1.-24. (canceled)

25. An apparatus comprising:
a memory; and
processing circuitry configured to cause the apparatus to:
request synchronization reference source information from a user equipment,
determine whether to conduct an offset compensation based on the synchronization reference source information, and
in response to a determination to conduct the offset compensation,
obtain a first propagation delay associated with the apparatus,
determine a reference time based on the first propagation delay, and
forward the reference time to the user equipment.

26. The apparatus according to 25, wherein the processing circuitry is further configured to cause the apparatus to:
obtain a second propagation delay between the user equipment and the apparatus; and
obtain a third propagation delay between the user equipment and a synchronization reference source based on the synchronization reference source information.

27. The apparatus according to 25, wherein the synchronization reference source information identifies a type of a synchronization source and a priority of the synchronization source.

28. The apparatus according to 26, wherein the processing circuitry is further configured to cause the apparatus to determine not to conduct the offset compensation in response to the synchronization reference source being a global navigation satellite system (GNSS).

29. The apparatus according to 26, wherein the processing circuitry is further configured to cause the apparatus to:
obtain the second propagation delay by transmitting a request to the user equipment to transmit a physical sidelink control channel (PSSCH) transmission with a reference signal including a transmission time and a reception time of a next PSSCH reception from the apparatus,
transmitting a first PSSCH transmission to the user equipment,
recording a first time of transmitting the first PSSCH transmission to the user equipment,
receiving a second PSSCH transmission from the user equipment,
recording a first reception time of receiving the second PSSCH transmission from the user equipment,
receiving, from the user equipment, a Rx-Tx value corresponding to a difference between the second transmission time of transmitting the second PSSCH transmission to the apparatus and a second reception time of receiving the first PSSCH transmission from the apparatus, and
determining the second propagation delay based on the Rx-Tx value, the first transmission time, and the first reception time.

30. The apparatus according to 26, wherein the processing circuitry is further configured to cause the apparatus to:
set an offset compensation value equal to the first propagation delay; and
determine the reference time based on the offset compensation value.

31. The apparatus according to 30, wherein the processing circuitry is further configured to cause the apparatus to:
determine whether the second propagation delay is greater than a first threshold and the third propagation delay is greater than a second threshold; and
set the offset compensation value equal to the offset compensation value plus the difference between the first propagation delay and the second propagation delay in response to the first propagation delay being greater than the second threshold and the third propagation delay being greater than the second threshold.

32. The apparatus according to 31, wherein the processing circuitry is further configured to cause the apparatus to:
set the offset compensation value equal to the offset compensation value plus the second propagation delay in response to the second propagation delay being greater than the first threshold and the third propagation delay not being greater than the second threshold.

33. The apparatus according to 31, wherein the processing circuitry is further configured to cause the apparatus to:
determine whether the first propagation delay is greater than a third threshold; and
set the offset compensation value equal to the offset compensation value minus the first propagation delay in response to the first propagation delay being greater than the third threshold.

34. An apparatus comprising:
a memory; and
processing circuitry configured to cause the apparatus to:
receive, from a first user equipment, a request for time information,
obtain a first propagation delay associated with a second user equipment,
determine a reference time based on the first propagation delay, and
forward the reference time to the first user equipment.

35. The apparatus according to claim 34, wherein the processing circuitry is further configured to:
obtain a second propagation delay between the first user equipment and the second user equipment; and
obtain a third propagation delay between the first user equipment and a synchronization reference source.

36. The apparatus according to claim 35, wherein the processing circuitry is further configured to cause the apparatus to:
set an offset compensation value equal to the first propagation delay; and
determine the reference time based on the offset compensation value.

37. The apparatus according to claim 36, wherein the processing circuitry is further configured to cause the apparatus to:
determine whether a second propagation delay is greater than a first threshold and a third propagation delay is greater than a second threshold; and
set the offset compensation value equal to the offset compensation value plus a difference between the first propagation delay and the second propagation delay in response to the first propagation delay being greater than the first threshold and the second propagation delay being greater than the second threshold.

38. A method for synchronizing a reference time in a sidelink relay, the method comprising:
requesting synchronization reference source information from a first user equipment;
determining whether to conduct an offset compensation based on the synchronization reference source information; and
in response to a determination to conduct the offset compensation,
obtaining a first propagation delay of a second user equipment,
determining a reference time based on the first propagation delay, and
forwarding the reference time to the first user equipment.

39. The method according to claim 38, further comprising:
obtaining a second propagation delay between the first user equipment and the second user equipment; and
obtaining a third propagation delay between the first user equipment and a synchronization reference source based on the synchronization reference source information.

40. The method according to claim 38, wherein the synchronization reference source information identifies a type of a synchronization source and a priority of the synchronization source, the method further comprising:
determining not to conduct the offset compensation in response to the synchronization source being a global navigation satellite system (GNSS).

41. The method according to claim 39, wherein the obtaining the second propagation delay comprises:
transmitting a request to the first user equipment to transmit a physical sidelink control channel (PSSCH) transmission with a reference signal including a transmission time and a reception time of a next PSSCH reception from the second user equipment;
transmitting a first PSSCH transmission to the first user equipment;
recording a first time of transmitting the first PSSCH transmission to the first user equipment;
receiving a second PSSCH transmission from the first user equipment;
recording a first reception time of receiving the second PSSCH transmission from the first user equipment;
receiving, from the first user equipment, a Rx-TX value corresponding to a difference between the second transmission time of transmitting the second PSSCH transmission to the second user equipment and a second reception time of receiving the first PSSCH transmission from the second user equipment; and
determining the second propagation delay based on the Rx-Tx value, the first transmission time, and the first reception time.

42. The method according to claim 38, wherein the determining the reference time comprises:
setting an offset compensation value equal to the first propagation delay; and
determining the reference time based on the offset compensation value.

43. The method according to claim 42, wherein the determining the reference time further comprises:
determining whether the second propagation delay is greater than a first threshold and a third propagation delay is greater than a second threshold;
setting the offset compensation value equal to the offset compensation value plus a difference between the second propagation delay and the third propagation delay in response to the second propagation delay being greater than the first threshold and the third propagation delay being greater than the second threshold; and
setting the offset compensation value equal to the offset compensation value plus the second propagation delay in response to the second propagation delay being greater than the first threshold and the third propagation delay not being greater than the second threshold.

44. The method according to claim 42, wherein the determining the reference time further comprises:
determining whether the first propagation delay is greater than a third threshold; and
setting the offset compensation value equal to the offset compensation value minus the first propagation delay in response to the first propagation delay being greater than the third threshold.
